(19) United States
(12) Patent Application Publication
(10) Pub. No.: US 2022/0381261 A1
(43) Pub. Date: Dec. 1, 2022

(54) PUMP CASING AND PUMP APPARATUS

(71) Applicant: EBARA CORPORATION, Tokyo (JP)

(72) Inventors: Soichiro OGAWA, Tokyo (JP); Yoichi NAKAMURA, Tokyo (JP); Shiao JIANG, Tokyo (JP); Dong Min KIM, Tokyo (JP)

(21) Appl. No.: 17/755,047

(22) PCT Filed: Nov. 2, 2020
(86) PCT No.: PCT/JP2020/041018

§ 371 Date: Apr. 20, 2022

(30) Foreign Application Priority Data
Nov. 5, 2019 (JP) 2019-200645

(51) Int. Cl. F04D 29/42; F04D 13/06

(52) U.S. Cl. CPC F04D 29/426; F04D 13/06

(57) ABSTRACT

The present invention relates to a reinforcing structure of a pump casing accommodating an impeller. A pump casing (8) includes: a volute hydro structure (22) having a discharge port (22a); a suction hydro structure (20) having a suction port (20a); and a rib (30) connected to outer surfaces of the volute hydro structure (22) and the suction hydro structure (20). The rib (30) has a curved outer edge (30A) which is curved toward the inside of the rib (30), and the curved outer edge (30A) is smoothly connected to the outermost peripheral surface (20b) of the suction hydro structure (20). A ratio of a radius of curvature (R1) of the curved outer edge (30A) to a radius of curvature (R2) of the outermost peripheral surface (20b) of the suction hydro structure (20) is 20% or more.

### TECHNICAL FIELD

The present invention relates to a pump casing, and more particularly to a reinforcing structure of a pump casing for accommodating an impeller therein. The present invention also relates to a pump apparatus including such a pump casing.

### BACKGROUND ART

A volute pump is configured to pressurize a liquid in a pump casing by rotating an impeller in the pump casing and discharge the pressurized liquid to an exterior through a discharge port. When the pressure of the liquid acts on the pump casing, a high stress is generated in a part of the pump casing, and the pump casing may be deformed. Such deformation of the pump casing may cause the pressurized liquid to leak out of the pump casing. Therefore, the pump casing is required to have a strength to keep the deformation of the pump casing below a certain level.

The pump casing having a volute chamber has a complicated shape. Therefore, the pump casing is typically made by casting. If the entire pump casing has a thick wall in order to increase the strength of the pump casing, the weight of the pump casing increases, and as a result, the weight of the entire volute pump increases.

On the other hand, if the pump casing is made thin, the mechanical strength of the pump casing is lowered, and as a result, the volute pump may not be able to pass a water-pressure resistance test. This water-pressure resistance test is conducted for the purpose of inspecting the volute pump for water leakage. Specifically, an impeller and a rotation shaft are removed from the pump casing, and all openings including a suction port and a discharge port of the pump casing are closed to form a closed space inside the pump casing. This closed space is then filled with water having a pressure 1.5 times a maximum discharge pressure of the pump. The pump casing, filled with the water, is left as it is for three minutes or more so that the pump casing is inspected for water leakage and deformation.

In addition to the above water-pressure resistance test, an inching test may be conducted. This inching test is a test in which the pump casing is inspected for water leakage by repeatedly increasing the pressure in the pump casing from no pressure condition to a certain level of pressure. The pump casing is required to have a high strength from the viewpoint of ensuring safe operation.

Thus, in order to increase the strength of the pump casing, a rib may be provided on an outer peripheral surface of the pump casing. FIG. 8 is a cross-sectional view showing an example of a conventional pump casing. A pump casing 200 has a suction hydro structure 201 having a suction port 201a, and a volute hydro structure 202 having a volute chamber 202a in which an impeller is housed and a discharge port 202b. A rib 205 extends from the suction hydro structure 201 to a discharge flange 206. Such a rib 205 can increase a second moment of area of the pump casing 200 and can therefore improve the strength of the pump casing 200.

### CITATION LIST

### Patent Literature

Patent document 1: Japanese laid-open patent publication No. 2007-291921

### SUMMARY OF INVENTION

### Technical Problem

However, stress analysis has shown the fact that when a high pressure is applied to the inside of the pump casing 200, the stress was concentrated on a connecting portion indicated by a reference symbol X in FIG. 8. This connecting portion X is a portion where the rib 205 and the suction hydro structure 201 are connected. When high stress is concentrated on the connecting portion X, a crack may be generated in an outer surface of the connecting portion X. This crack propagates toward the inside of the suction hydro structure 201 and may eventually reach an inner surface of the suction hydro structure 201. The crack that has reached the inside of the pump casing 200 causes liquid leakage from the pump casing 200. In particular, under an environment where the pump is frequently started and stopped, the crack grows rapidly and the life of the pump casing 200 is shortened.

Therefore, the present invention provides a pump casing capable of preventing liquid leakage even if a crack is generated in a rib by making it difficult for the crack to reach an inside of the pump casing. The present invention also provides a pump apparatus having such a pump casing. Solution to Problem

In an embodiment, there is provided a pump casing comprising: a volute hydro structure having a discharge port and a volute chamber for accommodating an impeller therein; a suction hydro structure having a suction port, the suction port communicating with the volute chamber; a rib connected to outer surfaces of the volute hydro structure and the suction hydro structure, wherein the rib has a curved outer edge that is curved inwardly of the rib, the curved outer edge is smoothly connected to an outermost peripheral surface of the suction hydro structure, and a ratio of a radius of curvature of the curved outer edge to a radius of curvature of the outermost peripheral surface of the suction hydro structure is 20% or more.

In an embodiment, a tangent line on the curved outer edge at a connection point between the curved outer edge of the rib and the outermost peripheral surface of the suction hydro structure coincides with a tangent line on the outermost peripheral surface of the suction hydro structure at the connection point.

In an embodiment, the rib is connected to a discharge flange that surrounds the discharge port.

In an embodiment, the curved outer edge of the rib extends from the suction hydro structure to the discharge flange.

In an embodiment, there is provided a pump apparatus comprising: an impeller; an electric motor coupled to the impeller; and the pump casing accommodating the impeller therein.

Advantageous Effects of Invention

According to the present invention, a stress is concentrated at a position away from the connecting portion between the rib and the suction hydro structure. In other words, the rib having the curved outer edge of the above-discussed radius of curvature can locate a stress-concentrated position away from the suction hydro structure.

Therefore, even if a crack is generated in the curved outer edge of the rib due to the stress concentration, the crack extends toward the inside of the rib and hardly reaches the suction hydro structure. That is, the crack is less likely to reach the suction hydro structure thanks to the height of the rib. As a result, this configuration can prevent the suction hydro structure itself from being cracked.

### BRIEF DESCRIPTION OF DRAWINGS

FIG. 1 is a cross-sectional view showing an embodiment of a pump apparatus;

FIG. 2 is a perspective view which shows an embodiment of a pump casing;

FIG. 3 is a bottom view of the pump casing shown in FIG. 2;

FIG. 4 is a side view of the pump casing shown in FIG. 2;

FIG. 5 is a side view of another embodiment of the pump casing;

FIG. 6 is a side view of still another embodiment of the pump casing;

FIG. 7 is a side view of still another embodiment of the pump casing; and

FIG. 8 is a cross-sectional view showing an example of a conventional pump casing.

### DESCRIPTION OF EMBODIMENTS

Hereinafter, embodiments of the present invention will be described with reference to the drawings.

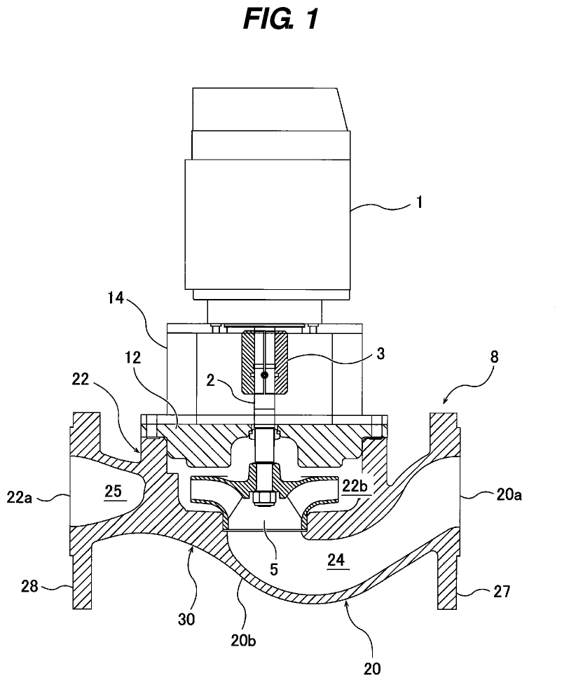

FIG. 1 is a cross-sectional view showing an embodiment of a pump apparatus. The pump apparatus of the present embodiment is an in-line pump apparatus having a suction port and a discharge port which are aligned in line. This type of pump apparatus has no leg, and the entire pump apparatus is supported by pipes coupled to a suction flange and a discharge flange.

The pump apparatus includes an electric motor 1, a rotation shaft 2 coupled to the electric motor 1 via a shaft coupling 3, an impeller 5 fixed to the rotation shaft 2, and a pump casing 8 accommodating the impeller 5. The impeller 5 is a centrifugal impeller. The impeller 2 is coupled to the electric motor 1 via the rotation shaft 2, and the rotation shaft 2 and the impeller 5 are integrally rotated by the electric motor 1.

A casing cover 12 and a motor base 14 are arranged between the electric motor 1 and the pump casing 8. An opening of the pump casing 8 is closed by the casing cover 12. The motor base 14 is fixed to the casing cover 12, and the electric motor 1 is fixed to the motor base 14. The pump casing 8 is a casting.

The pump casing 8 includes a suction hydro structure 20 having a suction port 20a, and a volute hydro structure 22 having a discharge port 22a and a volute chamber 22b. The impeller 5 is arranged in the volute chamber 22b. The suction port 20a and the discharge port 22a communicate with the volute chamber 22b. Specifically, the suction hydro structure 20 has a suction flow passage 24 coupled to the suction port 20a and the volute chamber 22b, and the suction port 20a communicates with the volute chamber 22b through the suction flow passage 24. The volume hydro structure 22 has a discharge flow passage 25 coupled to the volume chamber 22b and the discharge port 22a, and the discharge port 22a communicates with the volume chamber 22b through the discharge flow passage 25.

When the electric motor 1 rotates the impeller 5, a liquid flows from the suction port 20a of the suction hydro structure 20 through the suction flow passage 24 into the impeller 5 in the volute chamber 22b. The rotating impeller 5 imparts a velocity energy to the liquid, and the velocity energy of the liquid flowing through the volute chamber 22b is converted into pressure. The pressurized liquid flows through the discharge flow passage 25 of the volute hydro structure 22 and is discharged from the discharge port 22a.

The pump casing 8 has a suction flange 27 that surrounds the suction port 20a and a discharge flange 28 that surrounds the discharge port 22a. The suction port 20a and the discharge port 22a are aligned in a straight line. The pump casing 8 has no leg and the entire pump apparatus is supported by pipes (not shown) coupled to the suction flange 27 and the discharge flange 28. This pump apparatus having the suction port 20a and the discharge port 22a aligned in a straight line is called an in-line pump apparatus that can be incorporated between pipes.

The suction hydro structure 20 has an outermost peripheral surface 20b which is curved outwardly along the shape of the suction flow passage 24. The pump casing 8 includes a rib 30 smoothly connected to the outermost peripheral surface 20b of the suction hydro structure 20. This rib 30 is provided to increase a strength of the pump casing 8.

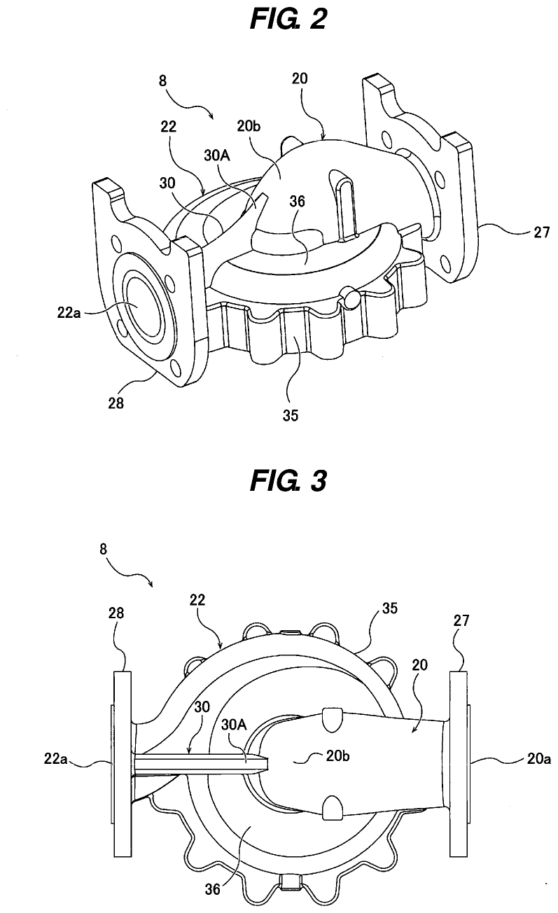

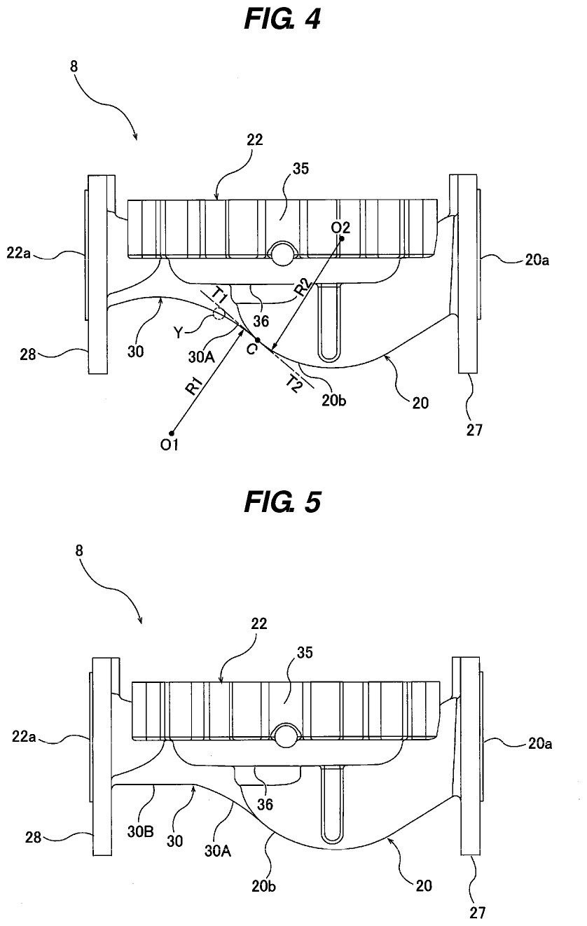

FIG. 2 is a perspective view of the pump casing 8, FIG. 3 is a bottom view of the pump casing 8, and FIG. 4 is a side view of the pump casing 8. The rib 30 extends outwardly in a radial direction of the volute chamber 22b from the suction hydro structure 20. As shown in FIG. 3, the suction port 20a, the rib 30, and the discharge port 22a are aligned in a straight line.

The volute hydro structure 22 has an outer peripheral wall 35 surrounding the volute chamber 22b and further has a volute wall 36 connected to the outer peripheral wall 35. The discharge port 22a is formed in an end of the volute wall 36. The suction hydro structure 20 is connected to a central portion of the volute wall 36.

The rib 30 is connected to an outer surface of the suction hydro structure 20 and an outer surface of the volute hydro structure 22. The outermost peripheral surface 20b of the suction hydro structure 20 is curved outwardly of the suction hydro structure 20. The rib 30 is connected smoothly to the curved outermost peripheral surface 20b of the suction hydro structure 20.

As shown in FIG. 4, the rib 30 has a curved outer edge 30A that is curved inwardly of the rib 30. The curved outer edge 30A is smoothly connected to the outermost peripheral surface 20b of the suction hydro structure 20. Specifically, a tangent line T1 on the curved outer edge 30A of the rib 30 at a connection point C between the outermost peripheral surface 20b of the suction hydro structure 20 and the curved outer edge 30A of the rib 30 coincides with a tangent line T2 on the outermost peripheral surface 20b of the suction hydro structure 20 at the connection point C.

A ratio (R1/R2×100) of a radius of curvature R1 of the rib 30 to a radius of curvature R2 of the outermost peripheral surface 20b of the suction hydro structure 20 is 20% or more. Preferably, the ratio of the radius of curvature R1 to the radius of curvature R2 is 50% or more, more preferably 100% or more. When the ratio of the radius of curvature R1 to the radius of curvature R2 is 100%, the radius of curvature R1 is equal to the radius of curvature R2. The radius of curvature R1 may be larger than the radius of curvature R2. As the radius of curvature R1 increases, the curved outer edge 30A of the rib 30 approaches a straight line. An upper limit of the radius of curvature R1, i.e., an upper limit of the ratio of the radius of curvature R1 to the radius of curvature R2 is not particularly limited. In other words, as long as the curved outer edge 30A of the rib 30 is smoothly connected to the outermost peripheral surface 20b of the suction hydro structure 20, the curved outer edge 30A may have a shape as close to a straight line as possible.

A center 01 of a circle of curvature of the curved outer edge 30A of the rib 30 is located outside the pump casing 8, and a center 02 of a circle of curvature of the outermost peripheral surface 20b of the suction hydro structure 20 is located inside the pump casing 8. In one embodiment, the radius of curvature R1 of the curved outer edge 30A of the rib 30 is the same as the radius of curvature R2 of the outermost peripheral surface 20b of the suction hydro structure 20. Alternatively, the curved outer edge 30A of the rib 30 has a shape similar to the outermost peripheral surface 20b of the suction hydro structure 20.

When the ratio of the radius of curvature R1 to the radius of curvature R2 is 20% or more, a stress-concentrated position can be located away from the suction hydro structure 20. According to a stress analysis, the stress-concentrated position is indicated by a reference symbol Y in FIG. 4 and is located away from the suction hydro structure 20. Therefore, even if a crack is generated in the curved outer edge 30A of the rib 30 due to the stress concentration, the crack propagates inside the rib 30 and hardly reaches the suction hydro structure 20. Specifically, the crack is less likely to reach the suction hydro structure 20 thanks to the height of the rib 30. As a result, this configuration can prevent the suction hydro structure 20 itself from being cracked.

The pump apparatus of the present embodiment is an in-line pump apparatus having the suction port 20a and the discharge port 22a which are aligned in a straight line. The in-line pump apparatus is a type of pump apparatus that can be installed between pipes. Specifically, the suction flange 27 is coupled to a suction pipe (not shown) and the discharge flange 28 is coupled to a discharge pipe (not shown), so that the entire pump apparatus is supported by the suction pipe and the discharge pipe. With such an installation, a bending moment is applied to the pump casing 8.

In the present embodiment, one end of the curved outer edge 30A of the rib 30 is connected to the outermost peripheral surface 20b of the suction hydro structure 20, and other end of the curved outer edge 30A of the rib 30 is connected to the discharge flange 28. Since the rib 30 extends from the suction hydro structure 20 to the discharge flange 28, the rib 30 can impart a sufficient mechanical strength to the pump casing 8 against the bending moment.

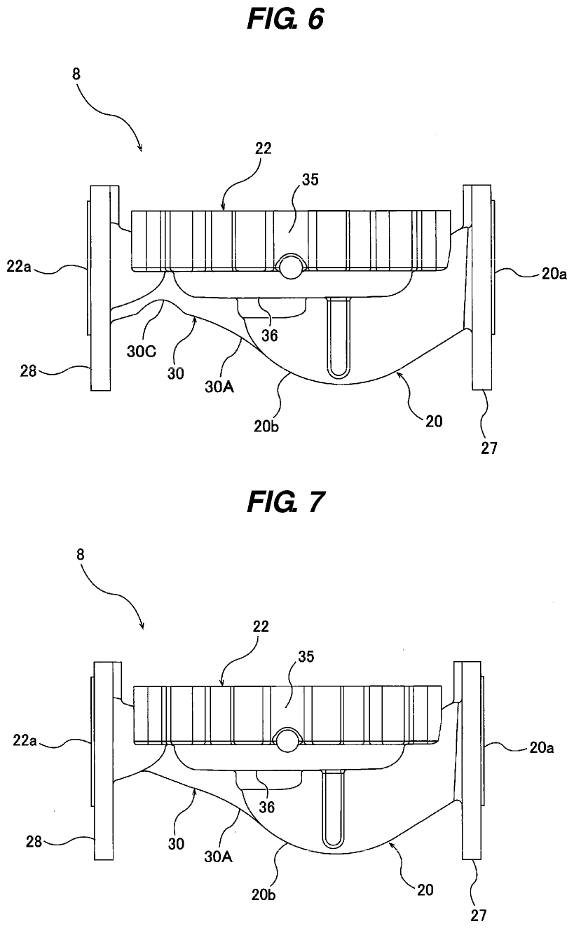

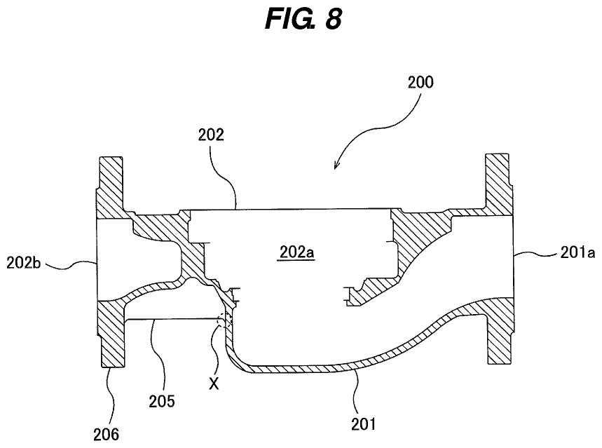

As long as the rib 30 has the curved outer edge 30A smoothly connected to the outermost peripheral surface 20b of the suction hydro structure 20, other portion of the rib 30 may not be curved. Specifically, the entire outer edge of the rib 30 may not be curved inwardly. For example, as shown in FIG. 5, the rib 30 may have a curved outer edge 30A and a linear outer edge 30B connected to the curved outer edge 30A. In another example, as shown in FIG. 6, the rib 30 may have a cut 30C formed in the curved outer edge 30A.

Depending on a weight and a shape of the pump apparatus, the rib 30 may not be connected to the discharge flange 28. For example, as shown in FIG. 7, the end of the rib 30 may be connected to the volute wall 36 of the volute hydro structure 22.

Also in the embodiments shown in FIGS. 5 to 7, the rib 30 has the curved outer edge 30A smoothly connected to the outermost peripheral surface 20b of the suction hydro structure 20, and the curvature of the curved outer edge 30A is the same as that of the embodiment described with reference to FIG. 4. Therefore, the rib 30 shown in FIGS. 5 to 7 can located the stress-concentrated position away from the suction hydro structure 20.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

### INDUSTRIAL APPLICABILITY

The present invention applicable to a reinforcing structure of a pump casing for housing an impeller therein. The present invention is also applicable to a pump apparatus having such a pump casing.

### REFERENCE SIGNS LIST

1 electric motor

2 rotation shaft

3 shaft coupling

5 impeller

8 pump casing

12 casing cover

14 motor base

20 suction hydro structure

20a suction port

20b outermost peripheral surface

22a discharge port

22b volute chamber

22 volute hydro structure

24 suction flow passage

25 discharge flow passage

27 suction flange

28 discharge flange

30 rib

30A curved outer edge

35 peripheral wall

36 volute wall

T1 tangent line

T2 tangent line

R1 radius of curvature

R2 radius of curvature

What is claimed is:

1. A pump casing comprising:
a volute hydro structure having a discharge port and a volute chamber for accommodating an impeller therein;
a suction hydro structure having a suction port, the suction port communicating with the volute chamber;
a rib connected to outer surfaces of the volute hydro structure and the suction hydro structure,
wherein the rib has a curved outer edge that is curved inwardly of the rib,
the curved outer edge is smoothly connected to an outermost peripheral surface of the suction hydro structure, and
a ratio of a radius of curvature of the curved outer edge to a radius of curvature of the outermost peripheral surface of the suction hydro structure is 20% or more.

2. The pump casing according to claim 1, wherein a tangent line on the curved outer edge at a connection point between the curved outer edge of the rib and the outermost peripheral surface of the suction hydro structure coincides with a tangent line on the outermost peripheral surface of the suction hydro structure at the connection point.

3. The pump casing according to claim 1, wherein the rib is connected to a discharge flange that surrounds the discharge port.

4. The pump casing according to claim 3, wherein the curved outer edge of the rib extends from the suction hydro structure to the discharge flange.

5. A pump apparatus comprising:
an impeller;
an electric motor coupled to the impeller; and
the pump casing according to claim 1, the pump casing accommodating the impeller therein.
